(19) United States
(12) Patent Application Publication
(10) Pub. No.: US 2026/0211225 A1
(43) Pub. Date: Jul. 23, 2026

(54) REAL-TIME PRECISION OPTICAL CONTROL SYSTEMS AND METHODS FOR LASER SCANNING MICROSCOPES

(71) Applicant: Purdue Research Foundation, West Lafayette, IN (US)

(72) Inventors: Chi Zhang, West Lafayette, IN (US); Bin Dong, West Lafayette, IN (US)

(73) Assignee: Purdue Research Foundation, West Lafayette, IN (US)

(21) Appl. No.: 19/449,123

(22) Filed: Jan. 14, 2026

Related U.S. Application Data
(60) Provisional application No. 63/748,676, filed on Jan. 23, 2025.

(51) Int. Cl. G02B 21/00

(52) U.S. Cl. CPC G02B 21/006; G02B 21/0048; G02B 21/0064; G02B 21/0076; G02B 21/008

(57) ABSTRACT

A precision optical control system for a laser scanning microscope includes a plurality of fiber-coupled continuous-wave lasers comprising at least one action laser and at least one excitation laser, a beam combining assembly, a beam steering assembly configured to direct beams across a sample in a scan pattern comprising discrete scan positions, a beam splitting element, at least one detector configured to detect fluorescence emission and generate an optical signal, and a controller configured to directly modulate the action laser via logic signals based on the optical signal. The direct modulation provides activation response times that enable precise spatial and temporal control of optical treatments at each scan position without requiring acousto-optic modulators. The system further comprising adjusting a power output of the at least one action laser via analog modulation based on an intensity of the optical signal during laser scanning.

### CROSS-REFERENCE TO RELATED APPLICATIONS

The present application claims priority to U.S. Provisional Application No. 63/748,676 filed Jan. 23, 2025, titled “REAL-TIME PRECISION OPTICAL CONTROL SYSTEMS AND METHODS FOR LASER SCANNING MICROSCOPES,” which is hereby incorporated by reference in its entirety.

### GOVERNMENT SUPPORT CLAUSE

This invention was made with government support under R35GM147092 awarded by National Institutes of Health. The government has certain rights in the invention.

### TECHNICAL FIELD

The embodiments disclosed herein generally relate to laser scanning microscopy systems, and more specifically to optical control systems and methods for real-time modulation of laser sources in laser scanning, stage scanning or other related real time laser microscopes.

### BACKGROUND

Laser scanning microscopy has become an important tool in biological and biomedical research, enabling high-resolution imaging of cellular structures and molecular processes. These systems typically employ one or more laser sources to excite fluorescent materials within a sample while scanning the laser beam across the sample to generate images. In many applications, researchers seek to not only image biological samples but also to perform targeted optical treatments such as photobleaching, photostimulation, or photouncaging of caged compounds at specific locations within the sample.

Conventional laser scanning microscopy systems that incorporate optical treatment capabilities often rely on acousto-optic modulators to control the activation and deactivation of treatment lasers. Acousto-optic modulators function by diffracting laser beams through acoustic waves generated within a crystal, allowing modulation of laser intensity and beam direction. While acousto-optic modulators provide reasonable control over laser output, they introduce inherent limitations in response time, typically on the order of several hundred nanoseconds, which can restrict the precision and speed of targeted optical treatments during scanning operations.

Additionally, many existing laser scanning systems require free-space optical alignment of laser sources, which demands careful manual adjustment and ongoing maintenance to ensure proper beam positioning. Free-space configurations can be sensitive to environmental factors and mechanical disturbances, potentially affecting system stability and requiring periodic realignment by trained personnel. The complexity of such optical arrangements can also increase the overall footprint of the microscopy system and limit its accessibility to researchers without specialized optical expertise.

Consequently, there is a need for improved optical control systems for laser scanning microscopes that provide faster response times for targeted optical treatments while simplifying system configuration and improving operational stability.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, variations of the disclosed real-time precision optical control system may include fiber-coupled continuous-wave lasers and integrated optical control components positioned for use with a laser scanning microscope. The system comprises action lasers and excitation lasers with direct modulation capability, beam combining and steering assemblies, detection components configured to generate optical signals from fluorescence emission, and a controller configured to modulate action lasers based on detected optical signals at discrete scan positions during scanning operations. The direct modulation enables nanosecond-level response times for precise spatial and temporal control of optical treatments, providing reliable operation while eliminating the response time limitations associated with conventional acousto-optic modulator-based systems.

In one aspect, variations of the disclosed laser scanning microscope may include an integrated configuration with fiber-coupled continuous-wave lasers and precision optical control technologies. The microscope incorporates a microscope frame with a motorized stage for three-dimensional sample positioning, optical assemblies for beam combining, steering, and splitting, and detection components configured to enable feedback-based control of optical treatments during scanning operations. The integrated design provides simultaneous imaging and targeted optical treatment capabilities in a compact and stable configuration.

In one aspect, variations of the disclosed method of performing precision optical control may include emitting beams from fiber-coupled continuous-wave lasers and directing the beams across a sample in a scan pattern. The method involves detecting fluorescence emission (or other optical signals from the sample) at each scan position and directly modulating action lasers via logic signals based on the detected optical signals to selectively deliver optical treatment to target regions. The operation process enables targeted optical treatments including photobleaching, reactive oxygen species generation, photouncaging, and optical stimulation with activation response times of less than 100 nanoseconds and deactivation response times of less than 50 nanoseconds, providing precise optical control that reduces treatment variability compared to conventional modulation approaches.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a schematic view of a precision optical control system showing the laser sources, optical assemblies, detection components, and controller configuration, according to some embodiments;

FIG. 2A illustrates a graph showing the activation response time of the optical control system, according to some embodiments;

FIG. 2B illustrates a graph showing the deactivation response time of the optical control system, according to some embodiments;

FIG. 3A illustrates fluorescence imaging of a sample showing the target region during optical treatment, according to some embodiments;

FIG. 3B illustrates fluorescence imaging of the sample of FIG. 3A showing the result following optical treatment, according to some embodiments; and

FIG. 4 illustrates a flowchart showing the method of performing precision optical control in a laser scanning microscope, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

For clarity and consistency, the same reference numerals will be used throughout the detailed description to refer to the same or corresponding components across the various figures. When a particular component is discussed while referring to a figure different from the one in which the component first appears, the reference numeral and original figure will be cited for clarity.

Terms such as “first,” “second,” “upper,” “lower,” “proximal,” and “distal” may be used in the following description for clarity with respect to the orientation of components as shown in the figures. These terms are not intended to be limiting and may be interpreted relative to the position or orientation of the real-time precision optical control system in actual use, which may vary.

Unless otherwise specified, the singular forms “a,” “an,” and “the” include plural referents. Components may be described functionally rather than structurally where appropriate for clarity. Any features or configurations disclosed as being optional or alternative may be implemented individually or in any suitable combination, as would be understood by one of ordinary skill in the art.

The disclosed real-time precision optical control system may include fiber-coupled continuous-wave lasers that provide electromagnetic radiation for both imaging and optical treatment applications in laser scanning microscopy. The lasers may be configured to deliver beams through fiber optic cables into a beam combining assembly, eliminating free-space alignment requirements and improving system stability compared to conventional laser scanning microscope configurations. In some embodiments, the continuous-wave lasers may include semiconductor laser sources with wavelengths selected for specific fluorescence excitation and optical treatment applications.

The real-time precision optical control system may comprise action lasers and excitation lasers that enable simultaneous imaging and targeted optical treatment of samples. The action lasers may be configured to deliver optical treatments such as photobleaching, reactive oxygen species generation, photouncaging, or optical stimulation to target regions within a sample. The excitation lasers may be configured to excite fluorescent material within the sample to generate fluorescence emission for imaging and feedback-based control. The action lasers may be directly modulated via logic signals, eliminating the need for acousto-optic modulators and providing activation response times of less than 100 nanoseconds and deactivation response times of less than 50 nanoseconds.

The real-time precision optical control system may also include a controller operably coupled to both the action lasers and detectors, configured to provide real-time feedback-based control of optical treatments during scanning operations. The controller may be configured to generate transistor-transistor logic signals programmatically via software or through a comparator circuit based on optical signals received from the detectors. The controller may also be configured to adjust power output of the action lasers via analog modulation based on the intensity of detected optical signals, enabling dynamic adjustment of treatment dosage based on molecular concentrations within the sample.

The real-time precision optical control system may be configured to direct beams of electromagnetic radiation across a sample in a scan pattern comprising a plurality of discrete scan positions, enabling selective activation or deactivation of action lasers at each scan position based on detected fluorescence emission. The systems may be configured to operate with beam steering assemblies that provide rapid and precise beam positioning within the sample plane. The beam steering assemblies may include reflective elements rotatable about respective axes to steer beams along two axes within the sample plane.

The real-time precision optical control system may include multiple optical configurations designed for different imaging and treatment applications. Each system configuration may incorporate the same direct modulation principles while providing specialized optical arrangements to address specific experimental requirements. In some embodiments, the system may include a motorized stage translatable along three orthogonal axes to enable three-dimensional positioning of the sample relative to the beams of electromagnetic radiation.

In use, researchers or laboratory personnel may position samples within the real-time precision optical control system and engage the scanning and detection mechanisms to perform simultaneous imaging and targeted optical treatment without the response time limitations of conventional acousto-optic modulator-based systems. The systems may be operated by configuring the controller to recognize specific fluorescence signals and activating action lasers at discrete scan positions where target structures or molecules are detected. The direct modulation of action lasers enables nanosecond-level response times that provide precise spatial and temporal control of optical treatments during high-speed scanning operations.

A biological research laboratory may utilize the real-time precision optical control system to investigate cellular signaling mechanisms through targeted photouncaging of caged compounds at specific locations within living cells or organisms. The nanosecond-level response times enable precise spatial control of compound release, allowing researchers to study signaling pathways with high temporal resolution. The feedback-based control allows optical treatment to be delivered selectively to regions exhibiting specific fluorescence characteristics, improving experimental precision compared to conventional approaches.

A developmental biology research group working with embryonic models may benefit from the system's ability to induce and monitor calcium wave propagation through localized photouncaging of ATP or other signaling molecules. The integrated imaging and treatment capabilities enable researchers to observe cellular responses in real-time while delivering precisely controlled optical stimulation. The three-dimensional positioning capabilities allow treatment and imaging across multiple focal planes within developing organisms.

A neuroscience laboratory may employ the real-time precision optical control system when performing optogenetic stimulation experiments that require precise spatial and temporal control of light delivery to specific neuronal populations. The nanosecond-level response times enable synchronization of optical stimulation with neural activity patterns, while the feedback-based control allows stimulation to be targeted based on detected fluorescence markers. The fiber-coupled laser configuration provides stable and reliable light delivery without the alignment sensitivity of free-space optical systems.

It should be noted that the use cases described above are merely illustrative examples of how the real-time precision optical control system may be utilized, and the practical applications are not limited to these specific scenarios. The direct modulation capability and feedback-based control features make the system suitable for a wide variety of laser scanning microscopy applications where precise spatial and temporal control of optical treatments provides advantages over conventional acousto-optic modulator-based systems.

The disclosed real-time precision optical control system provides a device that offers an improved alternative to conventional approaches configured to address the response time and stability challenges of laser scanning microscopy applications requiring targeted optical treatments. By incorporating fiber-coupled continuous-wave lasers with direct modulation capability, integrated beam combining and steering assemblies, and feedback-based control through detected fluorescence signals, the system enables precise optical control without acousto-optic modulator dependencies while eliminating the alignment complexity associated with free-space optical configurations. Unlike conventional systems that rely on acousto-optic modulators with response times of several hundred nanoseconds, this configuration provides nanosecond-level response times through direct laser modulation and incorporates feedback-based control to improve treatment precision, enabling laser scanning microscopy applications to proceed effectively in a variety of biological, developmental, and neuroscience research applications.

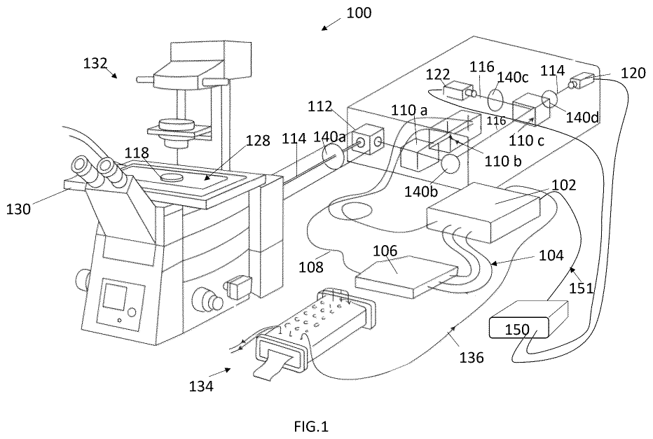

FIG. 1 illustrates a schematic view of a precision optical control system 100 showing the laser sources, optical assemblies, detection components, and controller configuration according to one embodiment of the disclosed invention. The precision optical control system 100 represents an integrated platform configured for simultaneous imaging and targeted optical treatment in laser scanning microscopy applications.

The precision optical control system 100 comprises a plurality of fiber-coupled continuous-wave lasers 102 that provide the electromagnetic radiation sources for both imaging and optical treatment operations. The plurality of fiber-coupled continuous-wave lasers 102 includes at least one action laser and at least one excitation laser. At least one action laser is configured to deliver optical treatment to a target region of a sample 118, while the at least one excitation laser is configured to excite fluorescent material within the sample 118 to generate fluorescence emission. Each of the plurality of fiber-coupled continuous-wave lasers 102 comprises an output configured to emit a beam of electromagnetic radiation at a predetermined wavelength. Each of the plurality of fiber-coupled continuous-wave lasers 102 features independently controllable power output and modulation modes, enabling precise and flexible operation tailored to experimental requirements.

In some embodiments, the plurality of fiber-coupled continuous-wave lasers 102 includes a first action laser configured to emit electromagnetic radiation at a wavelength of approximately 375 nanometers and a second action laser configured to emit electromagnetic radiation at a wavelength of approximately 405 nanometers. In some embodiments, the plurality of fiber-coupled continuous-wave lasers 102 includes a first excitation laser configured to emit electromagnetic radiation at a wavelength of approximately 488 nanometers and a second excitation laser configured to emit electromagnetic radiation at a wavelength of approximately 594 nanometers.

The first action laser and the second action laser may be configured to perform optical treatments such as photobleaching, reactive oxygen species (ROS) generation, photouncaging, or optical stimulation within the target region. The first excitation laser and the second excitation laser may be configured to excite fluorescent proteins or other fluorescent markers within the sample 118 for imaging purposes, enabling the identification and monitoring of organelles or other cellular structures during optical treatment operations.

The precision optical control system 100 further comprises fiber optic cables 104 that extend from the plurality of fiber-coupled continuous-wave lasers 102 to deliver the beams of electromagnetic radiation into the optical assembly. The fiber optic cables 104 provide a stable optical connection between the plurality of fiber-coupled continuous-wave lasers 102 and a beam combining assembly 106. The fiber-coupled configuration eliminates free-space alignment requirements that characterize conventional laser scanning microscope configurations, removing the need for manual laser coupling and periodic realignment procedures. The fiber-coupled configuration simplifies system setup and improves long-term reliability by reducing sensitivity to environmental factors and mechanical disturbances that can affect free-space optical arrangements.

The precision optical control system 100 further comprises a beam combining assembly 106 configured to receive the beams of electromagnetic radiation from the plurality of fiber-coupled continuous-wave lasers 102 via the fiber optic cables 104 and to direct the beams along a combined optical path. The beam combining assembly 106 integrates the multiple laser wavelengths into a collinear beam path that travels through the subsequent optical components of the precision optical control system 100.

The beam combining assembly 106 receives the beams through two separate integration paths to accommodate the different wavelength ranges of the plurality of fiber-coupled continuous-wave lasers 102. The second action laser at 405 nanometers, the first excitation laser at 488 nanometers, and the second excitation laser at 594 nanometers enter the beam combining assembly 106 through a laser combiner that merges these three wavelengths into a common beam path. The beam combining assembly 106 further comprises an optical filter configured as a short-pass filter to integrate electromagnetic radiation from the first action laser at 375 nanometers into the combined optical path. The short-pass filter enables efficient beam alignment and spectral separation by reflecting the 375 nanometer beam into alignment with the combined beam from the laser combiner. This two-path integration approach ensures that all four laser wavelengths travel along the combined optical path toward the sample 118.

The precision optical control system 100 further comprises a fiber coupler 108 positioned below the beam combining assembly 106. The action lasers 102 receive a logic signal connection 136 from a controller 134 or from the optical detector 120, 122 to enable direct modulation of the plurality of fiber-coupled continuous-wave lasers 102. The fiber coupler 108 delivers combined lasers to the laser scanning microscope.

The precision optical control system 100 further comprises a second optical element 140b positioned along the combined optical path between the beam combining assembly 106 and a beam splitting element 110a. The second optical element 140b may comprise a mirror to direct the combined beam toward the beam splitting element 110a via detection path 116.

The precision optical control system 100 further comprises a beam splitting element 110a positioned along the combined optical path. The beam splitting element 110a is configured to direct the beams of electromagnetic radiation toward the sample 118 and to transmit fluorescence emission from the sample 118 toward a detection path 116. The beam splitting element 110a comprises a multiband dichroic mirror that reflects excitation and treatment wavelengths toward the sample 118 while transmitting emitted fluorescence signals at different wavelengths toward the detection components.

The multiband dichroic mirror configuration of the beam splitting element 110a reflects electromagnetic radiation at the excitation and treatment wavelengths of approximately 405 nanometers, 488 nanometers, and 594 nanometers while transmitting fluorescence emission at wavelengths between and beyond the excitation wavelengths. This configuration optimizes signal collection and improves signal-to-noise ratio compared to systems using polarization beam splitters, as the dichroic approach provides more efficient separation between excitation light and fluorescence emission.

The precision optical control system 100 further comprises a beam steering assembly 112 positioned along the combined optical path between the beam splitting element 110a and the sample 118. The beam steering assembly 112 is configured to direct the beams of electromagnetic radiation across the sample 118 in a scan pattern comprising a plurality of discrete scan positions. The beam steering assembly 112 provides rapid and precise beam positioning within a sample plane, enabling high-speed scanning operations while maintaining accurate targeting of the beams at each of the plurality of discrete scan positions.

In some embodiments, the beam steering assembly 112 comprises at least two reflective elements, wherein each of the at least two reflective elements is rotatable about a respective axis to steer the beams of electromagnetic radiation along two axes within the sample plane. The two reflective elements may comprise galvanometer-driven mirrors that rotate in response to control signals from the controller 134, with one mirror controlling horizontal beam position and the other mirror controlling vertical beam position within the sample plane. The coordinated rotation of the two reflective elements enables the beam steering assembly 112 to position the combined beam at any location within the scan field, creating a raster scan pattern or targeting specific locations within the sample 118.

The precision optical control system 100 further comprises an excitation/treatment beam path 114 that extends from the beam steering assembly 112 toward the sample 118. The excitation/treatment beam path 114 represents the optical trajectory along which the combined beams travel after being steered by the beam steering assembly 112, passing through a microscope frame 132 to reach the sample 118. The excitation/treatment beam path 114 passes through objective optics within the microscope frame 132 that focus the beams to a diffraction-limited spot within the sample 118, enabling precise targeting of optical treatments to subcellular structures.

The precision optical control system 100 further comprises a microscope frame 132 that provides the structural support and optical pathway for directing the beams of electromagnetic radiation to the sample 118. The microscope frame 132 may comprise an inverted microscope configuration that positions the objective lens below the sample 118, enabling imaging and optical treatment of samples positioned on a motorized stage 130. The inverted configuration facilitates imaging of samples in culture dishes, multi-well plates, or other sample containers where optical access from below is preferred.

The precision optical control system 100 further comprises a motorized stage 130 coupled to the microscope frame 132. The motorized stage 130 is configured to support the sample 118 and is translatable along three orthogonal axes to enable three-dimensional positioning of the sample 118 relative to the beams of electromagnetic radiation. The motorized stage 130 provides precise sample positioning and enables Z-scan functionality for simultaneous three-dimensional imaging and treatment operations.

The translation along the Z-axis enables researchers to position the focal plane at different depths within the sample 118, while translation along the X and Y axes enables positioning of different regions of interest within the scan field. The three-dimensional positioning capability of the motorized stage 130 enables optical treatments to be delivered across multiple focal planes within the sample 118, supporting volumetric imaging and treatment applications.

The precision optical control system 100 further comprises a stage-top incubator 128 coupled to the motorized stage 130. The stage-top incubator 128 is configured to maintain environmental conditions for the sample 118 during imaging and optical treatment operations. The stage-top incubator 128 surrounds the sample 118 and may provide controlled temperature, humidity, and gas composition to support live cell or organism imaging over extended periods. The environmental control provided by the stage-top incubator 128 enables long-term experiments where cellular responses to optical treatment are monitored over hours or days.

The precision optical control system 100 further comprises the sample 118 positioned within the stage-top incubator 128 on the motorized stage 130. The sample 118 may comprise biological specimens including cells, tissues, or organisms containing fluorescent material that generates fluorescence emission when excited by the at least one excitation laser. The sample 118 includes target regions where at least one action laser may selectively deliver optical treatment based on detected fluorescence signals. In some embodiments, the sample 118 comprises zebrafish embryos expressing fluorescent calcium indicators such as GCaMP, enabling visualization of calcium dynamics during optical treatment operations.

The precision optical control system 100 further comprises a detection path 116 that extends from the beam splitting element 110c toward the detection components. The detection path 116 represents the optical trajectory along which fluorescence emission from the sample 118 travels after being transmitted through the beam splitting element 110c. The fluorescence emission is detected in an epi-direction, meaning the emitted fluorescence travels back through the same objective lens that delivered the excitation light to the sample 118, then passes through the beam splitting element 110c toward the detectors rather than being collected from the opposite side of the sample 118.

The epi-fluorescence detection configuration enables the precision optical control system 100 to collect fluorescence emission efficiently through high numerical aperture objectives while maintaining the excitation and treatment beam paths. The beam splitting element 110a separates the fluorescence emission from the excitation light based on wavelength, directing the fluorescence emission wavelengths toward the detection path 116 while reflecting excitation light wavelengths toward the sample 118.

The precision optical control system 100 further comprises a first optical element 140a positioned along the detection path 116 between the beam splitting element 110c and a first detector 120. The first optical element 140a may comprise a lens configured to focus or collimate the fluorescence emission traveling along the detection path 116. The precision optical control system 100 further comprises a third optical element 140c positioned along the detection path 116. The precision optical control system 100 further comprises a fourth optical element 140d positioned along the detection path 116 adjacent to the first detector 120.

The first optical element 140a, the third optical element 140c, and the fourth optical element 140d (collectively, optical elements 140a, 140c, and 140d) may comprise lenses, filters, or other optical components configured to condition the fluorescence emission before detection.

In some embodiments, an aperture is positioned along the detection path 116 and configured to reject out-of-focus light from the fluorescence emission. The aperture may comprise a pinhole that provides confocal detection capability by blocking fluorescence emission originating from focal planes above or below the focal plane of interest. The pinhole enables confocality by permitting only fluorescence emission from the in-focus plane to reach the detectors, while rejecting fluorescence from out-of-focus regions that would otherwise reduce image contrast and resolution. The confocal configuration enhances axial resolution and reduces background noise compared to widefield detection approaches.

In some embodiments, at least one optical filter is positioned along the detection path 116 and comprises a bandpass filter configured to selectively transmit a predetermined wavelength range of the fluorescence emission to at least one detector. The bandpass filter blocks residual excitation light and transmits only the desired fluorescence wavelengths, further improving signal-to-noise ratio by eliminating spectral contamination from the detected signals.

The precision optical control system 100 further comprises a first detector 120 positioned along the detection path 116. The first detector 120 is configured to detect the fluorescence emission from the sample 118 and to generate an optical signal corresponding to the detected fluorescence emission. The first detector 120 converts the incoming photons of fluorescence emission into an electrical signal that represents the intensity of fluorescence at each scan position.

The precision optical control system 100 further comprises a second detector 122 positioned along the detection path 116 adjacent to the first detector 120. The first detector 120 and the second detector 122 (collectively, detectors 120 and 122) may comprise photomultiplier tubes (PMTs) configured for high-sensitivity detection of the fluorescence emission. PMTs provide high gain and fast response times suitable for detecting low-level fluorescence signals during high-speed scanning operations.

In some embodiments, the detection path 116 further comprises a second beam splitting element 110c configured to direct a first portion of the fluorescence emission toward the first detector 120 and a second portion of the fluorescence emission toward the second detector 122. The second beam splitting element may comprise a dichroic mirror that separates the fluorescence emission by wavelength, directing shorter-wavelength fluorescence toward one detector and longer-wavelength fluorescence toward the other detector.

The splitting of the fluorescence emission between the first detector 120 and the second detector 122 enables simultaneous detection of multiple fluorescence wavelengths, supporting multi-channel imaging applications where different fluorescent markers emit at different wavelengths. In some embodiments, bandpass filters positioned before the detectors 120 and 122 further refine the detected wavelength ranges to reduce crosstalk between detection channels. For example, a first bandpass filter may transmit fluorescence emission in a range centered around 509 nanometers to the first detector 120, while a second bandpass filter may transmit fluorescence emission in a range centered around 642 nanometers to the second detector 122.

The precision optical control system 100 further comprises a controller 134 operably coupled to at least one action laser and the at least one detector. The controller 134 is configured to directly modulate at least one action laser via logic signals based on the optical signal received from the at least one detector. The direct modulation selectively activates or deactivates the at least one action laser in response to the optical signal at each of the plurality of discrete scan positions as the beam steering assembly 112 scans across the sample 118.

The controller 150 provides the computational and signal processing capabilities for real-time feedback-based control of the optical treatment operations. The controller 150 operates by receiving the optical signal from the detectors 120 and 122, evaluating the optical signal against predetermined criteria, and generating logic signals to modulate the at least one action laser based on the evaluation. This feedback loop enables the precision optical control system 100 to deliver optical treatment selectively to regions of the sample 118 that exhibit specific fluorescence characteristics, such as the presence of a particular fluorescent marker above a threshold intensity.

In some embodiments, the controller 150 comprises a comparator circuit configured to generate the logic signals based on the optical signal received from at least one detector. The comparator circuit provides hardware-based signal evaluation that generates logic signals with minimal latency, supporting the nanosecond-level response times of the precision optical control system 100.

In some embodiments, the controller 134 comprises software components configured to generate the logic signals programmatically based on the detected optical signals. The software components may execute algorithms that analyze the optical signal in real-time and determine whether to activate or deactivate the at least one action laser at each scan position. The controller 134 can be used in combination with the comparator circuit 150 for hybrid functions.

The controller 134 may comprise a data acquisition input/output (DAQ I/O) interface that coordinates the beam steering assembly 112 with the detection and modulation operations. The DAQ I/O interface synchronizes the scan position with the detected signals and the modulation commands, ensuring that the optical treatment is delivered precisely to the intended scan positions within the sample 118.

The precision optical control system 100 further comprises a logic signal connection 136 extending from the controller 134 to the fiber coupler 108 and to the plurality of fiber-coupled continuous-wave lasers 102. The logic signal connection 136 carries TTL signals or analog control signals that enable direct modulation of at least one action laser. The logic signals comprise transistor-transistor logic signals wherein a first logic state activates the at least one action laser and a second logic state deactivates the at least one action laser.

When a TTL “1” command is issued via the logic signal connection 136 or 151, at least one action laser is activated and the treatment beam is deflected to the target region within the sample 118. When a TTL “0” command is issued, the at least one action laser output is immediately shut off. The direct modulation via the logic signal connection 136 or 151 provides an activation response time of less than 100 nanoseconds and a deactivation response time of less than 50 nanoseconds. In some embodiments, the activation response time is approximately 75 nanoseconds with a rise time of approximately 10 nanoseconds. In some embodiments, the deactivation response time is approximately 30 nanoseconds with a fall time of approximately 4 nanoseconds.

The nanosecond-level response times enable precise spatial and temporal control of optical treatments at each of the plurality of discrete scan positions during scanning operations. The fast response times ensure that at least one action laser can be activated and deactivated within the dwell time at each scan position, enabling pixel-level control of optical treatment delivery across the scan field.

The direct modulation of the plurality of fiber-coupled continuous-wave lasers 102 via logic signals eliminates the need for acousto-optic modulators (AOMs) that characterize conventional laser scanning microscope configurations. AOMs function by diffracting laser beams through acoustic waves generated within a crystal, enabling modulation of laser intensity and beam direction. However, conventional AOM-based systems exhibit response times of approximately 500 nanoseconds, which limits the precision of targeted optical treatments during high-speed scanning. The direct modulation approach of the precision optical control system 100 achieves response times approximately six to seven times faster than AOM-based systems, enabling more precise targeting of optical treatments at individual scan positions.

In some embodiments, the controller 134 is further configured to adjust a power output of the at least one action laser via analog modulation based on an intensity of the optical signal received from the at least one detector. The analog modulation enables dynamic adjustment of treatment laser dosage based on the detected fluorescence intensity, wherein a higher intensity of the optical signal corresponds to a higher power output of the at least one action laser.

The analog power control capability enables treatment dosage to adjust dynamically based on optical signals and molecular concentrations within the sample 118. For example, regions of the sample 118 exhibiting higher fluorescence intensity may receive proportionally higher treatment laser power, enabling responsive optical treatment that adapts to local conditions within the target region. This analog modulation capability provides an additional level of control beyond the binary activation and deactivation provided by TTL modulation.

In some embodiments, the plurality of fiber-coupled continuous-wave lasers 102 comprises four laser sources with wavelengths of approximately 375 nanometers, 405 nanometers, 488nanometers, and 594 nanometers. In some embodiments, each of the plurality of fiber-coupled continuous-wave lasers 102 comprises semiconductor continuous-wave laser sources. In some embodiments, the beam steering assembly 112 comprises a two-dimensional galvanometer scanner configured to provide rapid beam positioning at scan rates suitable for real-time imaging and treatment applications.

In some embodiments, the precision optical control system 100 further comprises a pulsed light source configured to emit pulsed electromagnetic radiation, wherein the pulsed light source comprises a femtosecond laser. The pulsed light source may be operable as an additional action laser for optical treatment via multiphoton absorption. In some embodiments, the femtosecond laser is tunable from approximately 690 nanometers to approximately 1300 nanometers with a pulse duration of approximately 150 femtoseconds and peak power up to approximately 100 kilowatts. The femtosecond laser may be controlled in similar ways to the plurality of fiber-coupled continuous-wave lasers 102, providing enhanced capabilities for advanced optical manipulations based on multiphoton absorption mechanisms. The multiphoton absorption interaction mechanism enables optical treatments that are confined to the focal volume, providing intrinsic three-dimensional selectivity without requiring confocal detection.

In some embodiments, the detectors 120 and 122 comprise photomultiplier tubes configured for high-sensitivity detection of low-level fluorescence signals. In some embodiments, the motorized stage 130 comprises a motor focus drive system configured for automated Z-positioning. In some embodiments, the microscope frame 132 comprises an inverted microscope frame configured to position objective lenses below the sample 118. In some embodiments, the controller 134 comprises real-time processing capabilities configured to generate modulation signals within the nanosecond-level response times required for precise optical control at each scan position. In some embodiments, the precision optical control system 100 is configured in a confocal setup to enhance axial resolution and reduce background noise during imaging and optical treatment operations.

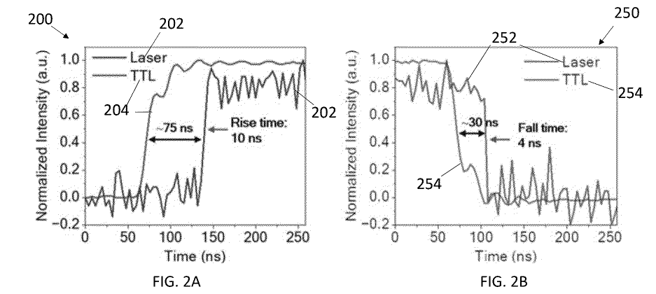

FIG. 2A illustrates a graph showing the activation response time of the precision optical control system 100 of FIG. 1 according to the same embodiment shown in FIG. 1. The activation response time graph 200 demonstrates the temporal relationship between the logic signal and the laser output when the at least one action laser transitions from an inactive state to an active state.

The activation response time graph 200 comprises a two-dimensional plot with a horizontal axis representing time and a vertical axis representing signal intensity. The horizontal axis of the activation response time graph 200 displays time measured in nanoseconds (ns), spanning from 0 nanoseconds at the origin to approximately 250 nanoseconds at the right edge of the graph. The horizontal axis enables visualization of the temporal sequence of events during the activation of the at least one action laser, with time progressing from left to right across the activation response time graph 200.

The vertical axis of the activation response time graph 200 displays normalized intensity measured in arbitrary units (a.u.), spanning from approximately −0.2 at the bottom to 1.0 at the top. The normalized intensity scale enables comparison between the logic signal amplitude and the laser output intensity on a common scale, with a value of 0 representing no signal or output and a value of 1.0 representing full signal or output. The normalization facilitates visualization of the relative timing between the logic signal transition and the laser intensity response without requiring absolute power measurements.

The activation response time graph 200 comprises a laser intensity trace 202 that represents the output intensity of the at least one action laser over time during the activation sequence. The laser intensity trace 202 appears as a curve within the activation response time graph 200 and is labeled “Laser” in the graph legend. The laser intensity trace 202 begins at a normalized intensity of approximately 0 on the left side of the activation response time graph 200, indicating that the at least one action laser is in the inactive state with no optical output. As time progresses along the horizontal axis, the laser intensity trace 202 remains at approximately 0 until the activation response begins, at which point the laser intensity trace 202 rises sharply toward a normalized intensity of approximately 1.0. The laser intensity trace 202 then maintains a normalized intensity of approximately 1.0 for the remainder of the time span shown in the activation response time graph 200, indicating that the at least one action laser has reached and is maintaining full optical output.

The activation response time graph 200 further comprises a logic signal trace 204 that represents the TTL signal delivered to the at least one action laser via the logic signal connection 136 of FIG. 1. The logic signal trace 204 appears as a curve within the activation response time graph 200 and is labeled “TTL” in the graph legend. The logic signal trace 204 displays the step function transition of the TTL signal from a first logic state to a second logic state. The first logic state corresponds to a TTL “0” command that maintains the at least one action laser in the inactive state, represented by a low value on the normalized intensity scale. The second logic state corresponds to a TTL “1” command that activates the at least one action laser, represented by a high value on the normalized intensity scale. The logic signal trace 204 transitions sharply from the low state to the high state at a specific time point, creating the step function that triggers the activation of the at least one action laser.

The relationship between the logic signal trace 204 and the laser intensity trace 202 demonstrates the response characteristics of the direct modulation approach employed by the precision optical control system 100. When the logic signal trace 204 transitions from the first logic state to the second logic state, the laser intensity trace 202 begins to rise after a brief delay. The time interval between the transition of the logic signal trace 204 and the beginning of the rise in the laser intensity trace 202 represents the activation response time of the precision optical control system 100.

The activation response time graph 200 indicates an activation response time of approximately 75 nanoseconds, measured from the transition of the logic signal trace 204 to the point where the laser intensity trace 202 begins to rise from the baseline. This measurement is indicated on the activation response time graph 200 by a horizontal arrow spanning from the logic signal transition to the beginning of the laser intensity rise, labeled as “~75 ns” on the graph. The activation response time represents the latency between the issuance of the TTL “1” command and the initial response of the at least one action laser. This activation response time of approximately 75 nanoseconds is less than 100 nanoseconds, satisfying the activation response time requirement for precise spatial and temporal control of optical treatments during scanning operations.

The laser intensity trace 202 further demonstrates a rise time of approximately 10 nanoseconds, measured as the time required for the laser intensity trace 202 to transition from approximately 10 percent to approximately 90 percent of the final intensity value. This measurement is indicated on the activation response time graph 200 by a horizontal arrow spanning the rising portion of the laser intensity trace 202, labeled as “Rise time: 10 ns” on the graph. The rise time represents the speed at which the at least one action laser reaches full output power after beginning to activate. The combination of the approximately 75 nanosecond activation response time and the approximately 10 nanosecond rise time results in a total activation time of approximately 85 nanoseconds from the issuance of the TTL “1” command to full laser output.

The activation response time demonstrated in the activation response time graph 200 enables the precision optical control system 100 to activate the at least one action laser within the dwell time at each of the plurality of discrete scan positions during scanning operations. The fast activation response ensures that optical treatment can be delivered precisely to target regions identified by the controller 134 or 150 of FIG. 1 based on the optical signal received from the at least one detector, without significant delay that would cause the treatment to be delivered to adjacent scan positions.

FIG. 2B illustrates a graph showing the deactivation response time of the precision optical control system 100 of FIG. 1 according to the same embodiment shown in FIG. 1. The deactivation response time graph 250 demonstrates the temporal relationship between the logic signal and the laser output when the at least one action laser transitions from an active state to an inactive state.

The deactivation response time graph 250 comprises a two-dimensional plot with a horizontal axis representing time and a vertical axis representing signal intensity, similar in structure to the activation response time graph 200 of FIG. 2A. The horizontal axis of the deactivation response time graph 250 displays time measured in nanoseconds (ns), spanning from 0 nanoseconds at the origin to approximately 250 nanoseconds at the right edge of the graph. The horizontal axis enables visualization of the temporal sequence of events during the deactivation of the at least one action laser, with time progressing from left to right across the deactivation response time graph 250.

The vertical axis of the deactivation response time graph 250 displays normalized intensity measured in arbitrary units (a.u.), spanning from approximately −0.2 at the bottom to 1.0 at the top. The normalized intensity scale corresponds to the scale used in the activation response time graph 200 of FIG. 2A, enabling direct comparison of activation and deactivation response characteristics.

The deactivation response time graph 250 comprises a laser intensity trace 252 that represents the output intensity of the at least one action laser over time during the deactivation sequence. The laser intensity trace 252 appears as a curve within the deactivation response time graph 250 and is labeled “Laser” in the graph legend. The laser intensity trace 252 begins at a normalized intensity of approximately 1.0 on the left side of the deactivation response time graph 250, indicating that the at least one action laser is in the active state with full optical output. As time progresses along the horizontal axis, the laser intensity trace 252 remains at approximately 1.0 until the deactivation response begins, at which point the laser intensity trace 252 falls sharply toward a normalized intensity of approximately 0. The laser intensity trace 252 then remains at approximately 0 for the remainder of the time span shown in the deactivation response time graph 250, indicating that the at least one action laser has ceased optical output and is maintaining the inactive state.

The deactivation response time graph 250 further comprises a logic signal trace 254 that represents the TTL signal delivered to the at least one action laser via the logic signal connection 136 or 150 of FIG. 1. The logic signal trace 254 appears as a curve within the deactivation response time graph 250 and is labeled “TTL” in the graph legend. The logic signal trace 254 displays the step function transition of the TTL signal from the second logic state to the first logic state. The second logic state corresponds to the TTL “1” command that maintains the at least one action laser in the active state, represented by a high value on the normalized intensity scale. The first logic state corresponds to the TTL “0” command that deactivates the at least one action laser and immediately shuts off the laser output, represented by a low value on the normalized intensity scale. The logic signal trace 254 transitions sharply from the high state to the low state at a specific time point, creating the step function that triggers the deactivation of the at least one action laser.

The relationship between the logic signal trace 254 and the laser intensity trace 252 demonstrates the deactivation response characteristics of the direct modulation approach employed by the precision optical control system 100. When the logic signal trace 254 transitions from the second logic state to the first logic state, the laser intensity trace 252 begins to fall after a brief delay. The time interval between the transition of the logic signal trace 254 and the beginning of the fall in the laser intensity trace 252 represents the deactivation response time of the precision optical control system 100.

The deactivation response time graph 250 indicates a deactivation response time of approximately 30 nanoseconds, measured from the transition of the logic signal trace 254 to the point where the laser intensity trace 252 begins to fall from the high intensity state. This measurement is indicated on the deactivation response time graph 250 by a horizontal arrow spanning from the logic signal transition to the beginning of the laser intensity fall, labeled as “~30 ns” on the graph. The deactivation response time represents the latency between the issuance of the TTL “0” command and the initial response of the at least one action laser to cease output. This deactivation response time of approximately 30 nanoseconds is less than 50 nanoseconds, satisfying the deactivation response time requirement for precise spatial and temporal control of optical treatments during scanning operations.

The laser intensity trace 252 further demonstrates a fall time of approximately 4 nanoseconds, measured as the time required for the laser intensity trace 252 to transition from approximately 90 percent to approximately 10 percent of the initial intensity value. This measurement is indicated on the deactivation response time graph 250 by a horizontal arrow spanning the falling portion of the laser intensity trace 252, labeled as “Fall time: 4 ns” on the graph. The fall time represents the speed at which the at least one action laser ceases output after beginning to deactivate. The combination of the approximately 30 nanosecond deactivation response time and the approximately 4-nanosecond fall time results in a total deactivation time of approximately 34 nanoseconds from the issuance of the TTL “0” command to complete cessation of laser output.

The deactivation response time demonstrated in the deactivation response time graph 250 is faster than the activation response time demonstrated in the activation response time graph 200 of FIG. 2A. The faster deactivation response enables the precision optical control system 100 to cease optical treatment rapidly when the beam steering assembly 112 of FIG. 1 moves to a scan position where treatment is not desired based on the optical signal received from the at least one detector. The rapid cessation of laser output prevents unintended optical treatment of regions adjacent to the target region within the sample 118 of FIG. 1.

The activation response time graph 200 of FIG. 2A and the deactivation response time graph 250 (collectively, response time graphs 200 and 250) demonstrate the performance characteristics that result from the direct modulation of the plurality of fiber-coupled continuous-wave lasers 102 of FIG. 1 via logic signals. The direct modulation approach eliminates the need for acousto-optic modulators that characterize conventional laser scanning microscope configurations. Conventional AOM-based systems exhibit response times of approximately 500 nanoseconds due to the time required for acoustic waves to propagate through the modulator crystal and establish the diffraction pattern that controls beam intensity.

The response time graphs 200 and 250 demonstrate that the direct modulation approach achieves activation response times approximately six to seven times faster than conventional AOM-based systems and deactivation response times approximately fifteen to seventeen times faster than conventional AOM-based systems. The improved response times enable more precise targeting of optical treatments at individual scan positions within the sample 118 of FIG. 1, as the at least one action laser can be activated and deactivated within shorter time intervals corresponding to smaller spatial displacements of the beam within the scan pattern.

The nanosecond-level response times demonstrated in the response time graphs 200 and 250 enable the precision optical control system 100 to perform pixel-by-pixel control of optical treatment delivery during high-speed scanning operations. At typical scan rates, each of the plurality of discrete scan positions may have a dwell time on the order of microseconds, providing sufficient time for the at least one action laser to be activated, deliver optical treatment, and be deactivated within a single scan position based on the optical signal evaluated by the controller 134 or 150 of FIG. 1.

In some embodiments, the activation response time is less than 100 nanoseconds. In some embodiments, the activation response time is approximately 75 nanoseconds. In some embodiments, the deactivation response time is less than 50 nanoseconds. In some embodiments, the deactivation response time is approximately 30 nanoseconds. In some embodiments, the rise time is approximately 10 nanoseconds. In some embodiments, the fall time is approximately 4 nanoseconds.

In some embodiments, the response times may vary based on the specific wavelength of the at least one action laser being modulated. In some embodiments, the response times may vary based on the power level at which the at least one action laser is operating. In some embodiments, the controller 134 or 150 of FIG. 1 compensates for the activation response time and the deactivation response time when generating logic signals to ensure that optical treatment is delivered precisely to the intended scan positions. In some embodiments, the response time is affected by fluorescence signal detection bandwidth and amplifier configuration. In some embodiments, the response time characteristics demonstrated in the response time graphs 200 and 250 are consistent across multiple activation and deactivation cycles, enabling reliable optical treatment delivery throughout extended imaging and treatment sessions.

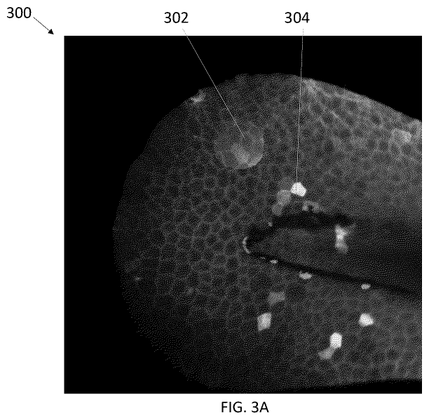

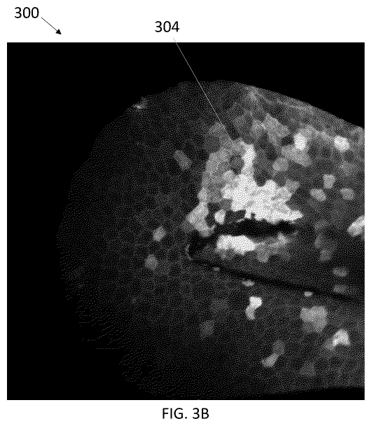

FIG. 3A illustrates fluorescence imaging of a sample 300 showing a target region 302 during to optical treatment according to the same embodiment shown in FIG. 1. FIG. 3A demonstrates the imaging capability of the precision optical control system 100 of FIG. 1 and illustrates the identification of the target region 302 within the sample 300 where optical treatment is to be delivered by the at least one action laser.

FIG. 3A comprises a fluorescence microscopy image captured by the precision optical control system 100 of FIG. 1 using the at least one excitation laser and the detectors 120 and 122 of FIG. 1. The fluorescence microscopy image displays the spatial distribution of fluorescence emission 304 within the sample 300, with brighter regions indicating higher concentrations of fluorescent material and darker regions indicating lower concentrations or absence of fluorescent material. The image is displayed with the fluorescence emission 304 appearing as green signal against a dark background, representing the detected fluorescence wavelengths transmitted through the detection path 116 of FIG. 1 to the detectors 120 and 122 of FIG. 1. This emission is from spontaneous calcium fluctuation in the sample.

The sample 300 comprises a biological specimen positioned within the stage-top incubator 128 of FIG. 1 on the motorized stage 130 of FIG. 1. In the embodiment shown in FIG. 3A, the sample 300 comprises a zebrafish embryo, which represents a model organism commonly used in biological research for studying developmental processes, cellular signaling, and wound healing mechanisms. The zebrafish embryo provides optical transparency that enables fluorescence imaging of internal cellular structures and molecular processes using the precision optical control system 100 of FIG. 1.

The sample 300 contains fluorescent material that generates the fluorescence emission 304 when excited by the at least one excitation laser. In the embodiment shown in FIG. 3A, the fluorescent material comprises a genetically encoded calcium indicator known as GCaMP, which is a fluorescent protein that increases in fluorescence intensity when calcium ions bind to the protein. The GCaMP calcium indicator enables visualization of intracellular calcium concentrations within the sample 300, with regions of higher calcium concentration appearing brighter in the fluorescence microscopy image. The at least one excitation laser, operating at a wavelength of approximately 488 nanometers as described with respect to FIG. 1, excites the GCaMP calcium indicator to generate the fluorescence emission 304 detected by the detectors 120 and 122 of FIG. 1.

The fluorescence emission 304 appears throughout the sample 300 in FIG. 3A, indicating the baseline distribution of calcium within the zebrafish embryo prior to optical treatment. The fluorescence emission 304 displays varying intensity levels across different regions of the sample 300, reflecting the natural distribution of intracellular calcium concentrations within the cells of the zebrafish embryo. The fluorescence emission 304 enables the controller 134 or 150 of FIG. 1 to generate electronic comments corresponding to the detected fluorescence at each of the plurality of discrete scan positions as the beam steering assembly 112 of FIG. 1 scans across the sample 300.

The target region 302 comprises an area within the sample 300 where optical treatment is to be delivered by the at least one action laser. In FIG. 3A, the target region 302 is indicated by a circled area within the sample 300, identifying the specific location where the at least one action laser will deliver optical treatment during the subsequent treatment phase. The target region 302 may be selected by the controller 134 of FIG. 1 based on the optical signal received from the at least one detector, enabling automatic identification of regions exhibiting specific fluorescence characteristics, or the target region 302 may be selected manually by a user operating the precision optical control system 100 of FIG. 1.

The target region 302 in FIG. 3A represents the area where the at least one action laser will perform photouncaging of a caged compound within the sample 300. In the embodiment shown, the caged compound comprises caged adenosine triphosphate (ATP), which is a biologically inactive form of ATP that becomes active when exposed to ultraviolet or near-ultraviolet light. The at least one action laser, operating at a wavelength of approximately 375 nanometers as described with respect to FIG. 1, delivers optical treatment to the target region 302 to photouncage the ATP, releasing active ATP within the localized area defined by the target region 302.

FIG. 3A represents the state of the sample 300 during the delivery of optical treatment to the target region 302. The fluorescence emission 304 in FIG. 3A reflects the baseline calcium distribution within the zebrafish embryo before the photouncaging event. The identification of the target region 302 in FIG. 3A demonstrates the capability of the precision optical control system 100 of FIG. 1 to image the sample 300 and identify specific regions for targeted optical treatment based on the detected fluorescence emission 304.

FIG. 3B illustrates fluorescence imaging of the sample 300 of FIG. 3A showing the result following optical treatment according to the same embodiment shown in FIG. 1. FIG. 3B demonstrates the effect of optical treatment delivered by the at least one action laser to the target region 302 in FIG. 3A and illustrates the biological response within the sample 300 following the photouncaging event.

FIG. 3B comprises a fluorescence microscopy image captured by the precision optical control system 100 of FIG. 1 at a time point following the delivery of optical treatment to the target region 302 shown in FIG. 3A. The fluorescence microscopy image in FIG. 3B displays the spatial distribution of fluorescence emission 304 within the sample 300 after the photouncaging of ATP within the target region 302. The image is displayed with the fluorescence emission 304 appearing as green signal against a dark background, using the same imaging parameters and display settings as FIG. 3A to enable direct comparison of the fluorescence distribution during and after optical treatment.

The sample 300 in FIG. 3B comprises the same zebrafish embryo location shown in FIG. 3A, imaged at a subsequent time point following the delivery of optical treatment to the target region 302. The sample 300 remains positioned within the stage-top incubator 128 of FIG. 1 on the motorized stage 130 of FIG. 1 throughout the imaging and treatment sequence, enabling continuous monitoring of the biological response to optical treatment.

The fluorescence emission 304 in FIG. 3B displays a substantially different spatial distribution compared to the fluorescence emission 304 in FIG. 3A. The fluorescence emission 304 in FIG. 3B appears expanded throughout a larger area of the sample 300, indicating that calcium concentrations have increased in regions beyond the original target region 302. The expanded fluorescence emission 304 represents a calcium wave that has propagated outward from the target region 302 following the photouncaging of ATP.

The target region 302 in FIG. 3B represents the area where optical treatment was delivered by the at least one action laser. The target region 302 in FIG. 3B corresponds to the same location identified in FIG. 3A, where the photouncaging of ATP occurred. The fluorescence emission 304 within and surrounding the target region 302 in FIG. 3B displays increased intensity compared to FIG. 3A, indicating elevated calcium concentrations resulting from the cellular response to the released ATP.

The comparison between FIG. 3A and FIG. 3B demonstrates the calcium wave propagation induced by localized ATP release within the target region 302. When ATP is photouncaged within the target region 302 by the at least one action laser operating at approximately 375 nanometers, the released ATP activates purinergic receptors on nearby cells, triggering an increase in intracellular calcium concentration. The increase in calcium concentration causes the GCaMP calcium indicator to increase in fluorescence intensity, producing the brighter fluorescence emission 304 visible in FIG. 3B. The calcium signal propagates to adjacent cells through gap junctions and extracellular signaling, creating the calcium wave visible as the expanded region of fluorescence emission 304 in FIG. 3B.

The calcium wave propagation demonstrated in FIG. 3A and FIG. 3B (collectively, application images 3A and 3B) provides valuable insights into the processes of cellular signaling and wound healing in living organisms. The ability to induce localized calcium waves through targeted photouncaging enables researchers to study the mechanisms underlying calcium-mediated signaling pathways and their role in coordinating cellular responses during development and tissue repair.

The application images of FIG. 3A and FIG. 3B demonstrate the capability of the precision optical control system 100 of FIG. 1 to perform simultaneous imaging and targeted optical treatment with precise spatial control. The at least one excitation laser operating at approximately 488 nanometers excites the GCaMP calcium indicator to generate the fluorescence emission 304, enabling continuous monitoring of calcium dynamics within the sample 300. Concurrently, the at least one action laser operating at approximately 375 nanometers delivers optical treatment to the target region 302 to photouncage ATP at the precise location identified through fluorescence imaging.

The nanosecond-level response times of the precision optical control system 100 demonstrated in the activation response time graph 200 of FIG. 2A and the deactivation response time graph 250 of FIG. 2B enable precise spatial control of the photouncaging event. The direct modulation of the at least one action laser via logic signals from the controller 134 of FIG. 1 ensures that optical treatment is delivered only to the target region 302, preventing unintended photouncaging in adjacent regions of the sample 300. The fast deactivation response time enables the at least one action laser to cease output rapidly as the beam steering assembly 112 of FIG. 1 moves to scan positions outside the target region 302, maintaining the spatial precision of the optical treatment.

The application images of FIG. 3A and FIG. 3B further demonstrate the feedback-based control capability of the precision optical control system 100 of FIG. 1. The controller 134 of FIG. 1 receives optical signals from the detectors 120 and 122 of FIG. 1 corresponding to the fluorescence emission 304 at each of the plurality of discrete scan positions. Based on the optical signals, the controller 134 of FIG. 1 can identify regions exhibiting specific fluorescence characteristics and selectively activate the at least one action laser to deliver optical treatment to those regions. This feedback-based control enables automatic targeting of optical treatments based on molecular markers or cellular structures identified through fluorescence imaging.

In some embodiments, the sample 300 comprises zebrafish embryos expressing genetically encoded calcium indicators. In some embodiments, the sample 300 comprises cultured cells, tissue sections, or other biological specimens containing fluorescent material. In some embodiments, the fluorescent material comprises synthetic fluorescent dyes, quantum dots, or other fluorescent markers in addition to or instead of genetically encoded fluorescent proteins.

In some embodiments, the optical treatment comprises photouncaging of caged ATP to induce calcium wave propagation. In some embodiments, the optical treatment comprises photouncaging of other caged compounds including caged neurotransmitters, caged signaling molecules, or caged therapeutic agents. In some embodiments, the optical treatment comprises photobleaching of fluorescent material within the target region 302 to study molecular diffusion or protein turnover. In some embodiments, the optical treatment comprises reactive oxygen species generation to induce localized oxidative stress within the target region 302. In some embodiments, the optical treatment comprises optical stimulation of optogenetic actuators to control cellular activity within the target region 302.

In some embodiments, the target region 302 comprises a single cell within the sample 300. In some embodiments, the target region 302 comprises a subcellular structure such as an organelle or membrane domain within a cell. In some embodiments, the target region 302 comprises a group of cells or a tissue region within the sample 300. In some embodiments, multiple target regions 302 are identified within the sample 300 for sequential or simultaneous optical treatment.

In some embodiments, the calcium wave propagation distance varies based on the intensity and duration of optical treatment delivered to the target region 302. In some embodiments, the controller 134 of FIG. 1 adjusts the power output of the at least one action laser via analog modulation based on the intensity of the optical signal received from the at least one detector, enabling dynamic adjustment of treatment dosage based on the detected fluorescence emission 304. In some embodiments, the motorized stage 130 of FIG. 1 translates the sample 300 along three orthogonal axes to enable optical treatment and imaging at multiple focal planes within the sample 300, supporting three-dimensional mapping of calcium wave propagation.

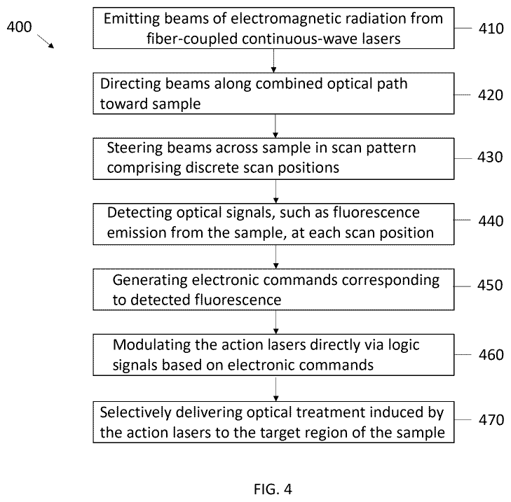

Embodiments of the present disclosure provide various methods for operating a precision optical control system to achieve targeted optical treatment functionality using feedback-based laser modulation, such as described herein. Various examples of the operations performed in accordance with some embodiments of the present disclosure will now be provided with reference to FIG. 4.

FIG. 4 illustrates a flowchart of a method 400 for performing precision optical control in a laser scanning microscope according to some embodiments. The method 400 outlines the operational sequence involved in achieving simultaneous imaging and targeted optical treatment, ensuring precise spatial and temporal control of optical treatments within biological, developmental, and neuroscience research applications.

The method 400 begins at operation 410, which involves emitting a plurality of beams of electromagnetic radiation from a plurality of fiber-coupled continuous-wave lasers. During this phase, the plurality of fiber-coupled continuous-wave lasers 102 of FIG. 1 emit beams of electromagnetic radiation at predetermined wavelengths through the fiber optic cables 104 of FIG. 1. The plurality of fiber-coupled continuous-wave lasers 102 of FIG. 1 includes at least one action laser and at least one excitation laser. The at least one action laser emits electromagnetic radiation configured to deliver optical treatment to a target region of a sample, while the at least one excitation laser emits electromagnetic radiation configured to excite fluorescent material within the sample to generate fluorescence emission.

In some embodiments, the at least one action laser emits electromagnetic radiation at a wavelength of approximately 375 nanometers or approximately 405 nanometers. In some embodiments, the at least one excitation laser emits electromagnetic radiation at a wavelength of approximately 488 nanometers or approximately 594 nanometers. In some embodiments, each of the plurality of fiber-coupled continuous-wave lasers 102 of FIG. 1 features independently controllable power output and modulation modes, enabling precise and flexible operation tailored to experimental requirements.

Operation 420 involves directing the plurality of beams of electromagnetic radiation along a combined optical path toward a sample. The beams of electromagnetic radiation from the plurality of fiber-coupled continuous-wave lasers 102 of FIG. 1 enter the beam combining assembly 106 of FIG. 1 via the fiber optic cables 104 of FIG. 1. The beam combining assembly 106 of FIG. 1 integrates the multiple laser wavelengths into a collinear beam path that travels toward the sample 118 of FIG. 1.

In some embodiments, the beam combining assembly 106 of FIG. 1 receives three of the laser wavelengths through a laser combiner and integrates a fourth wavelength via a short-pass filter. In some embodiments, the combined optical path passes through the second optical element 140b of FIG. 1 and the beam splitting elements 110a and 110b of FIG. 1 before reaching the beam steering assembly 112 of FIG. 1. The beam splitting elements 110a and 110b of FIG. 1 directs the beams of electromagnetic radiation toward the sample 118 of FIG. 1 while transmitting fluorescence emission from the sample 118 of FIG. 1 toward the detection path 116 of FIG. 1.

Operation 430 involves steering the plurality of beams of electromagnetic radiation across the sample in a scan pattern comprising a plurality of discrete scan positions. The beam steering assembly 112 of FIG. 1 directs the combined beams across the sample 118 of FIG. 1 in a controlled scan pattern. The beam steering assembly 112 of FIG. 1 positions the combined beams at each of the plurality of discrete scan positions in sequence, enabling the precision optical control system 100 of FIG. 1 to image and treat specific locations within the sample 118 of FIG. 1.

In some embodiments, the beam steering assembly 112 of FIG. 1 comprises at least two reflective elements that rotate about respective axes to steer the beams along two axes within a sample plane. In some embodiments, the scan pattern comprises a raster scan pattern that covers a rectangular field of view within the sample 118 of FIG. 1. In some embodiments, the scan pattern comprises a targeted scan pattern that visits specific locations within the sample 118 of FIG. 1 based on predetermined coordinates or regions of interest.

During operation 430, the at least one excitation laser excites fluorescent material within the sample 118 of FIG. 1 to generate fluorescence emission. As the beam steering assembly 112 of FIG. 1 positions the combined beams at each of the plurality of discrete scan positions, the at least one excitation laser illuminates the fluorescent material at each scan position. The fluorescent material absorbs the excitation light and emits fluorescence at longer wavelengths, generating the fluorescence emission that is detected in subsequent operations.

In some embodiments, the fluorescent material comprises genetically encoded fluorescent proteins such as GCaMP calcium indicators. In some embodiments, the fluorescent material comprises synthetic fluorescent dyes, quantum dots, or other fluorescent markers. In some embodiments, the method 400 further comprises translating a motorized stage supporting the sample along three orthogonal axes to enable three-dimensional positioning of the sample relative to the plurality of beams of electromagnetic radiation during the steering of the plurality of beams across the sample. The motorized stage 130 of FIG. 1 enables three-dimensional imaging and treatment by positioning different focal planes at the focus of the objective optics.

Operation 440 involves detecting the fluorescence emission from the sample at each of the plurality of discrete scan positions. The fluorescence emission generated by the excitation of fluorescent material travels back through the objective optics within the microscope frame 132 of FIG. 1 in an epi-direction configuration. The beam splitting element 110a of FIG. 1 transmits the fluorescence emission toward the detection path 116 of FIG. 1, separating the fluorescence emission from the excitation and treatment wavelengths based on wavelength differences.

The fluorescence emission travels along the detection path 116 of FIG. 1, passing through the optical elements 140a, 140c, and 140d of FIG. 1 before reaching the detectors 120 and 122 of FIG. 1. The detectors 120 and 122 of FIG. 1 detect the fluorescence emission at each of the plurality of discrete scan positions and convert the incoming photons into electrical signals.

In some embodiments, an aperture positioned along the detection path 116 of FIG. 1 rejects out-of-focus light from the fluorescence emission, providing confocal detection capability. In some embodiments, at least one optical filter positioned along the detection path 116 of FIG. 1 selectively transmits a predetermined wavelength range of the fluorescence emission to the detectors 120 and 122 of FIG. 1. In some embodiments, a second beam splitting element along the detection path 116 of FIG. 1 directs different portions of the fluorescence emission toward the first detector 120 of FIG. 1 and the second detector 122 of FIG. 1 based on wavelength, enabling multi-channel fluorescence detection.

Operation 450 involves generating an electronic command corresponding to the detected fluorescence emission. The detectors 120 and 122 of FIG. 1 convert the detected fluorescence emission into electrical signals that represent the intensity of fluorescence at each of the plurality of discrete scan positions. The electronic command comprises the electrical representation of the selected area that is transmitted to the controller 134 of FIG. 1 for processing and evaluation, or directly generated by the comparator circuit 150 based on optical signals from the sample at each pixel.

The optical signal generated at each of the plurality of discrete scan positions provides information about the fluorescence characteristics at that location within the sample 118 of FIG. 1. The controller 134 of FIG. 1 outputs electronic commands. The controller 150 receives optical signals and evaluates the signal against predetermined criteria to determine whether optical treatment should be delivered at each scan position.

In some embodiments, the optical signal represents the intensity of a single fluorescence channel detected by one of the detectors 120 or 122 of FIG. 1. In some embodiments, the optical signal represents a combination of signals from multiple detection channels. In some embodiments, the controller 150 of FIG. 1 compares the optical signal to a threshold value to determine whether fluorescence intensity at a given scan position indicates the presence of a target structure or molecule.

Operation 460 involves modulating directly the at least one action laser via logic signals based on the optical signal at each of the plurality of discrete scan positions. The controller 134 or 150 of FIG. 1 generates logic signals based on the evaluation of the optical signal and transmits the logic signals to the at least one action laser via the logic signal connection 136 of FIG. 1. The direct modulation selectively activates or deactivates the at least one action laser in response to the optical signal at each of the plurality of discrete scan positions as the beam steering assembly 112 of FIG. 1 scans across the sample 118 of FIG. 1.

The logic signals comprise transistor-transistor logic (TTL) signals wherein a first logic state activates the at least one action laser and a second logic state deactivates the at least one action laser. When a TTL “1” command is issued, the at least one action laser is activated and the treatment beam is deflected to the target region within the sample 118 of FIG. 1. When a TTL “0” command is issued, the at least one action laser output is immediately shut off.

The direct modulation provides an activation response time of less than 100 nanoseconds and a deactivation response time of less than 50 nanoseconds. In some embodiments, the activation response time is approximately 75 nanoseconds with a rise time of approximately 10 nanoseconds, as demonstrated in the activation response time graph 200 of FIG. 2A. In some embodiments, the deactivation response time is approximately 30 nanoseconds with a fall time of approximately 4 nanoseconds, as demonstrated in the deactivation response time graph 250 of FIG. 2B.

In some embodiments, the controller 134 of FIG. 1 generates the logic signals programmatically via software based on the detected optical signals. In some embodiments, the controller 134 of FIG. 1 comprises a comparator circuit that generates the logic signals based on the optical signal received from the detectors 120 and 122 of FIG. 1. The comparator circuit provides hardware-based signal evaluation that generates logic signals with minimal latency, supporting the nanosecond-level response times of the precision optical control system 100 of FIG. 1.

In some embodiments, the method 400 further comprises adjusting a power output of the at least one action laser via analog modulation based on an intensity of the optical signal. Higher intensity of the optical signal corresponds to higher power output of the at least one action laser, enabling dynamic adjustment of treatment dosage based on detected fluorescence intensity and molecular concentrations within the sample 118 of FIG. 1.

Operation 470 involves selectively delivering optical treatment to a target region of the sample. The at least one action laser, when activated by the logic signals from the controller 134 of FIG. 1, delivers optical treatment to the target region within the sample 118 of FIG. 1. The optical treatment is delivered at each of the plurality of discrete scan positions where the controller 134 or 150 of FIG. 1 has determined that treatment should occur based on the optical signal.

The selective delivery of optical treatment enables the precision optical control system 100 of FIG. 1 to target specific structures, cells, or molecular populations within the sample 118 of FIG. 1 based on their fluorescence characteristics. The nanosecond-level response times demonstrated in the response time graphs 200 and 250 of FIGS. 2A and 2B ensure that optical treatment is delivered precisely to the intended scan positions without unintended treatment of adjacent regions.

In some embodiments, selectively delivering optical treatment to the target region comprises performing photobleaching within the target region. Photobleaching involves the irreversible destruction of fluorescent molecules through prolonged or intense illumination, enabling studies of molecular diffusion, protein turnover, and membrane dynamics.

In some embodiments, selectively delivering optical treatment to the target region comprises performing reactive oxygen species (ROS) generation within the target region. ROS generation involves the creation of chemically reactive molecules containing oxygen through photochemical reactions, enabling studies of oxidative stress responses and localized cell damage.

In some embodiments, selectively delivering optical treatment to the target region comprises performing photouncaging within the target region. Photouncaging involves the light-induced release of biologically active molecules from inactive caged precursors, enabling precise spatial and temporal control of molecular signaling. The photouncaging of caged ATP within zebrafish embryos, as demonstrated in the application images 3A and 3B of FIGS. 3A and 3B, illustrates the capability of the method 400 to induce calcium wave propagation through localized ATP release.

In some embodiments, selectively delivering optical treatment to the target region comprises performing optical stimulation within the target region. Optical stimulation involves the light-induced activation of optogenetic actuators such as channelrhodopsins, enabling precise control of cellular activity in neurons and other excitable cells.

The method 400 provides a feedback-based approach to achieving targeted optical treatment functionality in laser scanning microscopy applications. The use of direct modulation via logic signals with nanosecond-level response times enables precise spatial and temporal control of optical treatments at each of the plurality of discrete scan positions. The feedback loop established by detecting fluorescence emission, generating optical signals, and modulating the action laser based on the optical signals enables automatic targeting of optical treatments based on molecular markers or cellular structures identified through fluorescence imaging.

The method 400 eliminates the response time limitations associated with conventional acousto-optic modulator-based systems, which exhibit response times of approximately 500 nanoseconds. The direct modulation approach achieves activation response times approximately six to seven times faster than conventional AOM-based systems, enabling more precise targeting of optical treatments during high-speed scanning operations. The improved response times enable pixel-by-pixel control of optical treatment delivery, ensuring that treatments are delivered only to scan positions exhibiting the desired fluorescence characteristics.

In some embodiments, the method 400 is performed continuously during extended imaging sessions, enabling real-time monitoring and treatment of dynamic biological processes. In some embodiments, the method 400 is performed at multiple focal planes within the sample 118 of FIG. 1 by translating the motorized stage 130 of FIG. 1 along the Z-axis between scan sequences. In some embodiments, the method 400 is repeated for multiple target regions within the sample 118 of FIG. 1, enabling sequential treatment of different structures or cell populations during a single imaging session.

It should be noted that additional operations or variations may be included in the method 400, depending on the specific requirements of the research application or the configuration of the precision optical control system 100 of FIG. 1. For example, the method 400 may include operations for adjusting scan parameters based on sample characteristics or treatment requirements. Additionally, the method 400 may involve operations for calibrating the response time characteristics of the at least one action laser or optimizing the threshold criteria used by the controller 134 or 150 of FIG. 1 for generating logic signals.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A precision optical control system for a laser scanning microscope, the system comprising:
a plurality of fiber-coupled continuous-wave lasers, wherein each of the plurality of fiber-coupled continuous-wave lasers comprises an output configured to emit a beam of electromagnetic radiation, wherein the plurality of fiber-coupled continuous-wave lasers includes at least one action laser and at least one excitation laser, wherein the at least one action laser is configured to deliver optical treatment to a target region of a sample, wherein the at least one excitation laser is configured to excite fluorescent material within the sample to generate fluorescence emission;
a beam combining assembly configured to receive the beams of electromagnetic radiation from the plurality of fiber-coupled continuous-wave lasers and to direct the beams along a combined optical path;
a beam steering assembly positioned along the combined optical path, wherein the beam steering assembly is configured to direct the beams of electromagnetic radiation across the sample in a scan pattern comprising a plurality of discrete scan positions;
a beam splitting element positioned along the combined optical path, wherein the beam splitting element is configured to direct the beams of electromagnetic radiation toward the sample and to transmit fluorescence emission from the sample toward a detection path;
at least one detector positioned along the detection path, wherein the at least one detector is configured to detect the fluorescence emission from the sample and to generate an optical signal corresponding to the detected fluorescence emission; and
a controller operably coupled to the at least one action laser and the at least one detector, wherein the controller is configured to directly modulate the at least one action laser via logic signals based on the optical signal received from the at least one detector, wherein the direct modulation selectively activates or deactivates the at least one action laser in response to the optical signal at each of the plurality of discrete scan positions as the beam steering assembly scans across the sample, wherein the direct modulation provides an activation response time of less than 100 nanoseconds and a deactivation response time of less than 50 nanoseconds.

2. The system of claim 1, wherein the logic signals comprise transistor-transistor logic signals, wherein a first logic state activates the at least one action laser and a second logic state deactivates the at least one action laser.

3. The system of claim 2, wherein the controller is configured to generate the transistor-transistor logic signals programmatically via software.

4. The system of claim 2, wherein the controller comprises a comparator circuit configured to generate the transistor-transistor logic signals based on the optical signal received from the at least one detector.

5. The system of claim 1, wherein the controller is further configured to adjust a power output of the at least one action laser via analog modulation based on an intensity of the optical signal received from the at least one detector.

6. The system of claim 1, wherein the beam steering assembly comprises at least two reflective elements, wherein each of the at least two reflective elements is rotatable about a respective axis to steer the beams of electromagnetic radiation along two axes within a sample plane.

7. The system of claim 1, further comprising a motorized stage configured to support the sample, wherein the motorized stage is translatable along three orthogonal axes to enable three-dimensional positioning of the sample relative to the beams of electromagnetic radiation.

8. The system of claim 1, wherein the beam combining assembly comprises an optical filter, wherein the optical filter comprises a short-pass filter configured to integrate electromagnetic radiation from a first of the plurality of fiber-coupled continuous-wave lasers into the combined optical path.

9. The system of claim 1, further comprising at least one optical filter positioned along the detection path, wherein the at least one optical filter comprises a bandpass filter configured to selectively transmit a predetermined wavelength range of the fluorescence emission to the at least one detector.

10. The system of claim 1, further comprising an aperture positioned along the detection path, wherein the aperture is configured to reject out-of-focus light from the fluorescence emission.

11. The system of claim 1, wherein the at least one detector comprises a first detector and a second detector, wherein the detection path further comprises a second beam splitting element configured to direct a first portion of the fluorescence emission toward the first detector and a second portion of the fluorescence emission toward the second detector.

12. The system of claim 1, further comprising a pulsed light source configured to emit pulsed electromagnetic radiation, wherein the pulsed light source comprises a femtosecond laser, wherein the pulsed light source is operable as an additional action laser for optical treatment via multiphoton absorption.

13. A laser scanning microscope comprising:
a microscope frame;
a motorized stage coupled to the microscope frame, wherein the motorized stage is configured to support a sample and is translatable along three orthogonal axes to enable three-dimensional positioning of the sample;
a plurality of fiber-coupled continuous-wave lasers, wherein each of the plurality of fiber-coupled continuous-wave lasers comprises an output configured to emit a beam of electromagnetic radiation, wherein the plurality of fiber-coupled continuous-wave lasers includes at least one action laser configured to deliver optical treatment to a target region of the sample and at least one excitation laser configured to excite fluorescent material within the sample to generate fluorescence emission;
a beam combining assembly configured to receive the beams of electromagnetic radiation from the plurality of fiber-coupled continuous-wave lasers and to direct the beams along a combined optical path;
a beam steering assembly positioned along the combined optical path, wherein the beam steering assembly is configured to direct the beams of electromagnetic radiation across the sample in a scan pattern comprising a plurality of discrete scan positions;
a beam splitting element positioned along the combined optical path, wherein the beam splitting element is configured to direct the beams of electromagnetic radiation toward the sample and to transmit the fluorescence emission from the sample toward a detection path;
at least one detector positioned along the detection path, wherein the at least one detector is configured to detect the fluorescence emission and to generate an optical signal corresponding to the detected fluorescence emission; and
a controller operably coupled to the at least one action laser and the at least one detector, wherein the controller is configured to directly modulate the at least one action laser via logic signals based on the optical signal at each of the plurality of discrete scan positions, wherein the direct modulation provides an activation response time of less than 100 nanoseconds.

14. The laser scanning microscope of claim 13, further comprising a stage-top incubator coupled to the motorized stage, wherein the stage-top incubator is configured to maintain environmental conditions for the sample during imaging and optical treatment.

15. The laser scanning microscope of claim 13, further comprising an aperture positioned along the detection path and at least one optical filter positioned along the detection path between the aperture and the at least one detector, wherein the aperture is configured to reject out-of-focus light from the fluorescence emission, wherein the at least one optical filter comprises a bandpass filter configured to selectively transmit a predetermined wavelength range of the fluorescence emission to the at least one detector.

16. The laser scanning microscope of claim 13, wherein the direct modulation further provides a deactivation response time of less than 50 nanoseconds.

17. A method of performing precision optical control in a laser scanning microscope, the method comprising:
emitting a plurality of beams of electromagnetic radiation from a plurality of fiber-coupled continuous-wave lasers, wherein the plurality of fiber-coupled continuous-wave lasers includes at least one action laser and at least one excitation laser;
directing the plurality of beams of electromagnetic radiation along a combined optical path toward a sample;
steering the plurality of beams of electromagnetic radiation across the sample in a scan pattern comprising a plurality of discrete scan positions;
exciting fluorescent material within the sample with the at least one excitation laser to generate fluorescence emission;
detecting the fluorescence emission from the sample at each of the plurality of discrete scan positions;
generating an electronic command corresponding to the detected fluorescence emission; and
modulating directly the at least one action laser via logic signals based on the optical signal at each of the plurality of discrete scan positions to selectively deliver optical treatment to a target region of the sample, wherein the direct modulation provides an activation response time of less than 100 nanoseconds and a deactivation response time of less than 50 nanoseconds.

18. The method of claim 17, further comprising adjusting a power output of the at least one action laser via analog modulation based on an intensity of the optical signal, wherein a higher intensity of the optical signal corresponds to a higher power output of the at least one action laser.

19. The method of claim 17, wherein selectively delivering optical treatment to the target region comprises performing at least one of photobleaching, reactive oxygen species generation, photouncaging, or optical stimulation within the target region.

20. The method of claim 17, further comprising translating a motorized stage supporting the sample along three orthogonal axes to enable three-dimensional positioning of the sample relative to the plurality of beams of electromagnetic radiation during the steering of the plurality of beams across the sample.
